(19) United States
(12) Patent Application Publication
(10) Pub. No.: US 2014/0351032 A1
(43) Pub. Date: Nov. 27, 2014

(54) Name Based Customer Referral System

(71) Applicant: MENTION ME LTD, Bexhill-On-Sea (GB)

(72) Inventors: Andrew Daniel Cockburn, London (GB); Timothy James Boughton, London (GB)

(73) Assignee: MENTION ME LTD, Bexhill-On-Sea (GB)

(21) Appl. No.: 14/284,675

(22) Filed: May 22, 2014

Related U.S. Application Data
(60) Provisional application No. 61/826,184, filed on May 22, 2013.

(51) Int. Cl. G06Q 30/02

(52) U.S. Cl. CPC G06Q 30/0214
USPC 705/14.16

(57) ABSTRACT

Methods and apparatus, including computer program products, for managing a referral program. One or more of a name and additional identifying details for a referrer are registered in a database. A referrer's name is received from a referred party. It is verified whether the referrer's name provided by the referred party matches a registered referrer's name in the database. Additional identity information is used to verify a referrer's identity in the event that two registered referrers have identical names. A reward is granted to the referrer after a specified act has been completed by the referred party.

### FIELD OF THE INVENTION

This invention relates to information processing. Specifically, this invention relates to information processing methods for marketing and selling goods using a referral process and system.

### BACKGROUND

A common problem encountered by merchants is the difficulty in cost-effectively finding new customers. One way of finding new customers involves offering rewards to existing customers for bringing in new customers. This is typically referred to as “the referral channel” or as “refer-a-friend programs.” Existing refer-a-friend programs encourage sharing to happen, for example, via electronic mail or on Social Networking websites, such as www.facebook.com, or on micro-blogging sites, such as www.twitter.com. This is often ineffective as many people choose not to share in this way and so do not refer. On the other hand, in conversation individuals are likely to refer to products and services that they enjoy, but they rarely have any means of sharing a referral offer in that forum.

### SUMMARY

In general, in one aspect, the various embodiments of the invention provide methods and apparatus, including computer program products, for managing a referral program. One or more of a name and additional identifying details for a referrer are registered in a database. A referrer's name is received from a referred party. It is verified whether the referrer's name provided by the referred party matches a registered referrer's name in the database. Additional identity information is used to verify a referrer's identity in the event that two registered referrers have identical names. A reward is granted to the referrer after a specified act has been completed by the referred party.

The various embodiments of the invention can include one or more of the following features. Registering can include receiving one or more of the name, the email address and the additional identifying details for the referrer by the referrer entering information using a website. Registering can include receiving one or more of the name, the email address and the additional identifying details for the referrer through a third party login to provide the information. The third party login can include a login to one or more of a social networking website, a micro-blogging website, and an online profile. The referrer can be identified by first name and last name. The additional information can include one or more of: an image of the referrer, an email for the referrer, a telephone number for the referrer, a complete address for the referrer, a partial address for the referrer, a username for the referrer, a customer identification number for the referrer, and a code for the referrer. A reward can be granted to the referred party after a specified act has been completed by the referred party. The reward can include a coupon code, cash, rebate, third party vouchers, a free product, free services, upgrades, virtual goods, charity donations, or points.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 shows a process (100) for enrolling an individual or entity to be able to refer a merchant using their name, in accordance with one embodiment.

FIG. 2 shows a process (200) for an individual who has been referred to a merchant to be able to access their introductory offer using the referrer's name, in accordance with one embodiment.

FIG. 3 shows a system (300) for managing the referral and reward process, in accordance with one embodiment.

### DETAILED DESCRIPTION

### Overview

In general, the various embodiments of this invention relate to information processing methods for marketing and selling goods using a referral process and system. A name-based customer referral system enables individuals and their network of individuals to access rewards for referring merchants by using their name as an identifier. When interacting with a merchant, an individual is offered a reward. The reward is contingent upon the individual introducing other individuals or entities to the merchant and is further contingent on those individuals or entities completing a specified act.

In accordance with one embodiment, the referrer opts in to promote the merchant by providing their name and some other piece of identifying information, such as a cell phone number or an email address, for example. The referrer is then able to approach others and offer them a reward if they provide the referrer's name to the merchant and then complete the specified act. When a name is provided, the merchant checks the name and whether the referrer's name is unique within the merchant's database of referred names. If the referrer's name matches a registered name in the database of referred names, the merchant offers the referred party a reward, contingent on the specified act being completed by the referred party. Once the specified act has been completed by the referred party, the merchant also gives the referrer the agreed reward. In the event that the referrer's name exists in the merchant's database of referred names, but is not unique, the merchant may ask for additional identifying information, such as an email address or a cell phone number, to confirm the identity of the referrer.

As will be described in further detail below, various embodiments of the invention can include one or more of the following features. The merchant offer can be given in an online or an offline environment, such as on a website, in a store or over the phone. The referrer can choose to provide their details in multiple ways, such as entering their name and email address on a web site, completing a paper form with their name and email address, or registering using a third party login, such as a social networking, micro-blogging or other website that is able to provide the system with name and other identifying information, such that the referrer can use the system. The referred party may be asked to provide only a name in order to provide the referrer's identity. Alternatively, the referred party may be asked to also provide additional proof of identity, such as an email address, a telephone number, or the selection of the referrer's profile photo, just to mention a few alternatives. The rewards and introductory offers that are offered to the referrer and to the referred person may take any format including a coupon code, cash, rebate, third party vouchers, free product(s), free services, upgrades, virtual goods, charity donations, points or nothing at all. As the skilled person realizes, these are merely a few examples, and many further variations and combinations are available to those of ordinary skill in the art.

Various embodiments of the invention can be implemented to include one or more of the following advantages. The barrier for customers to share with other people is reduced compared to what is currently the case. As a result, customers are not only more likely to share with others, but also more likely to share with more people. Those people are more likely to become customers of the merchant having engaged in a conversation with the referrer about the merchant. They are also likely to be more satisfied customers and to spend more money. After having had a positive referral experience, those customers who are referred parties are more likely to share with others using the techniques described herein.

### Glossary of Terms and Acronyms

The following terms are used throughout the detailed description.

Merchant. An entity that is looking to encourage individuals or entities with whom is it already in communication to entice others to enter into communication with it and to perform a specified act.

Referral Program. A set of rewards established by a merchant to encourage individuals or entities to become referrers and to encourage referred parties to complete a specified act.

Referred Party. An individual or entity that has been put in contact with a merchant by a referrer.

Referrer. An individual or entity that has been made aware of a Referral Program by a Merchant and has shared details of the Referral Program with other individuals or entities.

Rewards. Incentives made available to both the Referrer and the Referred Party upon the completion of the Specified Act. Examples of rewards include one or more of: a coupon code, cash, rebate, third party vouchers, free product, free services, upgrades, virtual goods, charity donations and points.

Specified Act. An action that the Merchant is willing to reward when a Referred Party comes to them. One example of a Specified Act is for the referred party to be required to purchase something from the merchant. Other examples of Specified Acts include various types of activities, such as registering, joining a membership scheme, or signing up for a newsletter.

Third Party Login. A means for referrers to provide their name and other identifying information. For example, rather than providing their name and email address directly, an individual may choose to provide the information by logging into a third party website and giving the third party permission to provide specified information. Examples of commonly used third party logins include www.facebook.com and www.twitter.com.

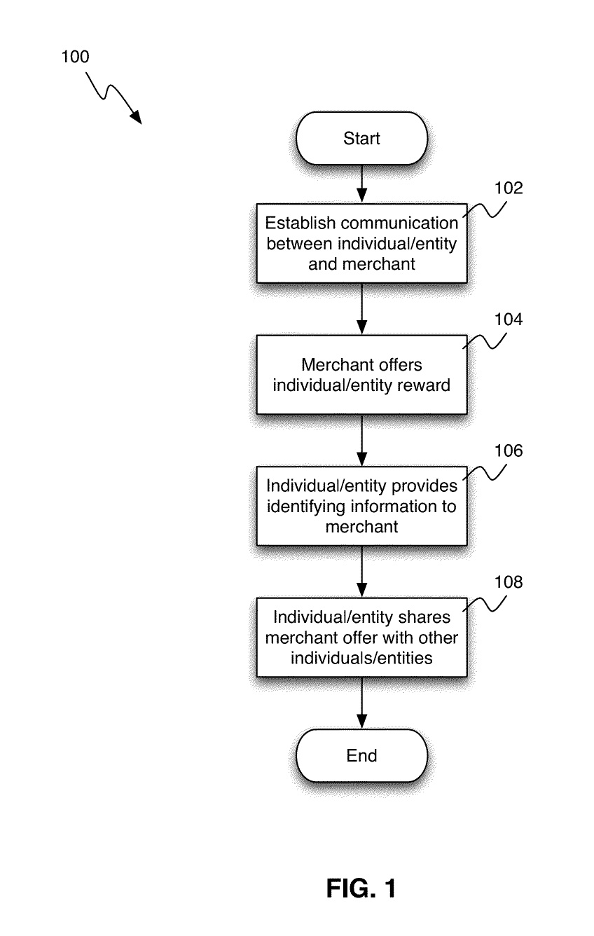

As shown in FIG. 1, a process (100) for referring a product or service starts by an individual or entity establishing communication with a merchant (step 102). In one embodiment, this occurs in an online interaction, but as the skilled person realizes, this may also happen, for example, at a merchant's premises, or over the phone.

During the communication the individual or entity is offered a reward by the merchant (step 104). The reward is contingent upon the individual or entity convincing other individuals or entities to complete a specified act (102). In some embodiments, the individual or entity may additionally be incentivized to perform the specified act himself or herself by being offered, for example, a reward or introductory offer.

In order to be able to take part in the Referral Program the individual provides identifying information to the merchant (step 106). In one embodiment, the identifying information includes at a minimum the individual or entity's name and email address. In other embodiments, the identifying information can also include additional information, such as an address or a cell phone number, for example. The identifying information can be provided in a variety of ways, such as entering the identifying information in an online form, or providing the identifying information in writing or verbally to the merchant. In some embodiments, the individual may also choose to provide their identifying information through a third party service, such as a social network, micro-blogging site or some other form of online profile. Further, as the skilled person realizes, in some embodiments, the merchant may already have the identifying details and the individual or entity will not need to provide their details but will be asked to confirm that they are willing to enter into the referral program.

Once the individual or entity has provided their details, the individual or entity shares the merchant's offer with others who may be interested in the offer (step 108). In doing so the individual or entity becomes a “referrer.” In a typical embodiment, the referrer tells others to go to the merchant store or online website and enter or give their name in order to receive the agreed introductory offer.

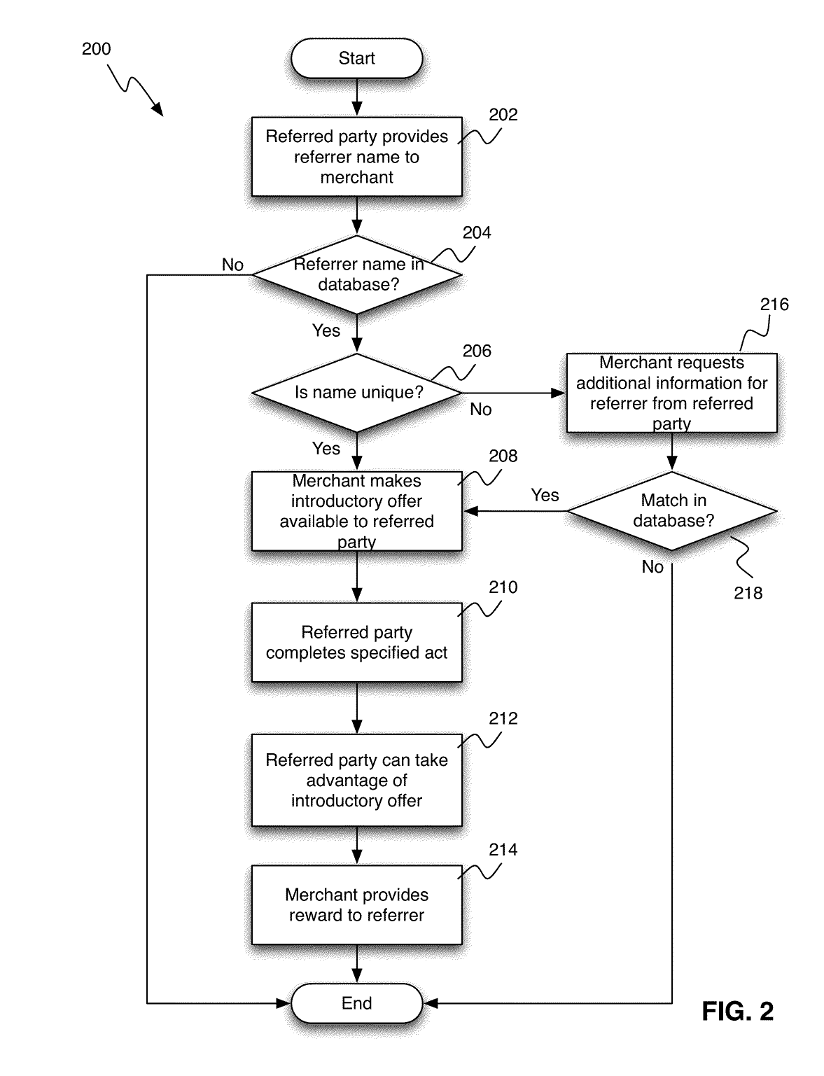

FIG. 2 shows a process (200) detailing the experience of a “referred party.” As can be seen in FIG. 2, the process (200) starts with the referred party providing the name of the referrer to the merchant (step 202). In one embodiment, this is done in an online interaction. However, as the skilled person realizes, in other embodiments, this may also happen at a merchant's premises or over the phone.

Next, the provided name is checked against the merchant's database of referrers (step 204). If the referrer's name does not exist in the database, no offers or rewards will be provided and the process (200) ends. In some embodiments, the referred party will optionally also receive a message to that effect (not shown).

If it is determined in step 204 that the referrer's name exists in the database, the process checks whether the name is unique (step 206). If the referrer's name is unique, then the introductory offer that was communicated to the referrer is made available to the referred party (step 208). Next, the referred party completes the specified act that is contained in the offer (step 210). After completing the specified act, the referred party can take advantage of the merchant's offer (step 212). Some examples of ways in which the offer may be made available to the referred party include: showing a promotional code on their computer screen, asking the referred party to log in to a secure section of a site to access information about redemption, being sent a promotional code, a money transfer or voucher by electronic mail or being sent a coupon or check in the mail.

In some embodiments, an optional step 214 can be included in the process (200), in which the referrer is also provided with a reward, in response to the referred party performing the specified act. This ends the process (200).

Returning now to step 206, if the referrer's name is not unique in the merchant's database, the system requires additional information to be able to identify the referrer (step 216). For example, if the referrer has provided an email address, the referred party is asked to provide an email address belonging to the referrer. The process then checks whether the additional information matches additional information associated with the referrer's name in the database (step 218). If there is a match, then the process continues to step 208, and proceeds as described above. If there is no match with additional information stored in the database, the process (200) ends.

In some embodiments, if the referrer has provided a third party login and other referrers of the same name have also all provided a third party login and all of those third party logins have enabled images of the referrers to be captured, then the system can provides images in order for the referred party to be able to identify the referrer by their appearance in step 216. Once an image has been selected, then the introductory offer that was communicated to the referrer is made available to the referred party and the process continues as described above.

In some embodiments, if the referrer has provided a third party login but not all other referrers of the same name have also all provided a third party login, then the referred party can be asked to provide an email address belonging to the referrer in step 216. If that email address matches the email address in the database, then the introductory offer that was communicated to the referrer is made available to the referred party and the process continues as described above.

In yet some embodiments, if a referred party is asked to provide an email address in step 216 and they do so but the email address does not match an email address for any of the referrers in the database, then efforts will be made to contact the referrer using the provided email address to ask them to confirm the email address that they provided the merchant within step 106 of FIG. 1. As can be seen, many variations of the process (200) are possible, which all fall within the scope of the appended claims.

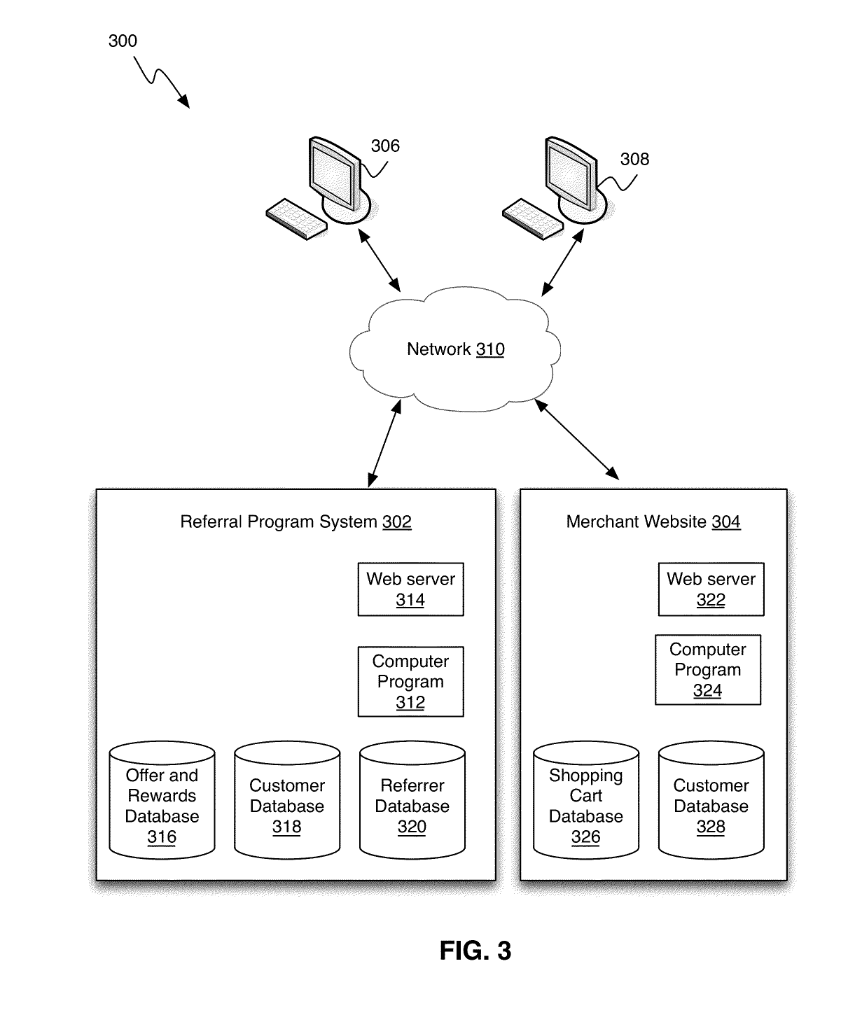

FIG. 3. shows an exemplary system (300), in which the above processes (100, 200) can be performed, in accordance with one embodiment. The system (300) includes a referral program system (302), a merchant web site (304), a referrer's computer (306), and a referred party's computer (308). All of these system components exchange information over a network (310), such as the Internet, using standard client-server protocols, such as the hypertext transfer protocol (HTTP).

In one embodiment, the referral program system (302) includes a computer program (312) that manages the logic that determines what webpages and information are served to the referrer's computer (306) and the referred party's computer (308) by a web server (314) in the referral program system (302), in response to performing the various steps of the processes (100, 200) described above with respect to FIGS. 1 and 2. The information that is served by the web server (314) derives from an offers and rewards database (316), a customer database (318) and a referrer database (320).

In situations where the referral program is working with an online merchant, the referral program system works alongside the merchant website (304) such that the referral offers and process appears in and among the other information and content being served by the merchant's web server (322), having been specified by a computer program (324) and the information having been retrieved from a shopping cart database (326) and a customer database (328).

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, referrer, referred party or merchant, the invention can be implemented on a computer system having a display device such as a monitor or LCD screen for displaying information to the user. The user can provide input to the computer system through various input devices such as a keyboard and a pointing device, such as a mouse, a trackball, a microphone, a touch-sensitive display, a transducer card reader, a magnetic or paper tape reader, a tablet, a stylus, a voice or handwriting recognizer, or any other well-known input device such as, of course, other computers. The computer system can be programmed to provide a graphical user interface through which computer programs interact with users.

Finally, the processor optionally can be coupled to a computer or telecommunications network, for example, an Internet network, or an intranet network, using a network connection, through which the processor can receive information from the network, or might output information to the network in the course of performing the above-described method steps. Such information, which is often represented as a sequence of instructions to be executed using the processor, may be received from and outputted to the network, for example, in the form of a computer data signal embodied in a carrier wave. The above-described devices and materials will be familiar to those of skill in the computer hardware and software arts.

It should be noted that the present invention employs various computer-implemented operations involving data stored in computer systems. These operations include, but are not limited to, those requiring physical manipulation of physical quantities. Usually, though not necessarily, these quantities take the form of electrical or magnetic signals capable of being stored, transferred, combined, compared, and otherwise manipulated. The operations described herein that form part of the invention are useful machine operations. The manipulations performed are often referred to in terms, such as, producing, identifying, running, determining, comparing, executing, downloading, or detecting. It is sometimes convenient, principally for reasons of common usage, to refer to these electrical or magnetic signals as bits, values, elements, variables, characters, data, or the like. It should remembered however, that all of these and similar terms are to be associated with the appropriate physical quantities and are merely convenient labels applied to these quantities.

Embodiments of the present invention also relate to a device, system or apparatus for performing the aforementioned operations. The system may be specially constructed for the required purposes, or it may be a general-purpose computer selectively activated or configured by a computer program stored in the computer. The processes presented above are not inherently related to any particular computer or other computing apparatus. In particular, various general-purpose computers may be used with programs written in accordance with the teachings herein, or, alternatively, it may be more convenient to construct a more specialized computer system to perform the required operations.

A number of implementations of the invention have been described. Nevertheless, it will be understood that various modifications may be made without departing from the spirit and scope of the invention. For example, where a referrer's name has been provided by a referred party but is not unique in the database the system may use additional data beyond email address or photo as a means of verifying the referrer's identity. Accordingly, other embodiments are within the scope of the following claims.

1. A computer-implemented method for managing a referral program, the method comprising:
registering in a database one or more of: a name and additional identifying details for a referrer;
receiving, from a referred party, a referrer's name;
verifying whether the referrer's name provided by the referred party matches a registered referrer's name in the database, wherein additional identity information is used to verify a referrer's identity where two registered referrers have identical names; and
granting a reward to the referrer after a specified act has been completed by the referred party.

2. The method of claim 1, wherein registering further comprises:
receiving one or more of the name, the email address and the additional identifying details for the referrer by the referrer entering information using a website.

3. The method of claim 1, wherein registering further comprises:
receiving one or more of the name, the email address and the additional identifying details for the referrer through a third party login to provide the information.

4. The method of claim 3, wherein the third party login includes a login to one or more of a social networking website, a micro-blogging website, and an online profile.

5. The method of claim 1 wherein the referrer is identified by first name and last name.

6. The method of claim 1, wherein the additional information includes one or more of: an image of the referrer, an email for the referrer, a telephone number for the referrer, a complete address for the referrer, a partial address for the referrer, a username for the referrer, a customer identification number for the referrer, and a code for the referrer.

7. The method of claim 1, further comprising:
granting a reward to the referred party after a specified act has been completed by the referred party.

8. The method of claim 1, wherein the reward includes one or more of:
a coupon code, cash, rebate, third party vouchers, a free product, free services, upgrades, virtual goods, charity donations, points.

9. A computer program product for managing a referral program, the computer program product comprising a non-transitory computer readable storage medium having program code embodied therewith, the program code being executable by a processor to perform a method comprising:
registering in a database one or more of: a name and additional identifying details for a referrer;
receiving, from a referred party, a referrer's name;
verifying whether the referrer's name provided by the referred party matches a registered referrer's name in the database, wherein additional identity information is used to verify a referrer's identity where two registered referrers have identical names; and
granting a reward to the referrer after a specified act has been completed by the referred party.

10. The computer program product of claim 9, wherein registering further comprises:
receiving one or more of the name, the email address and the additional identifying details for the referrer by the referrer entering information using a website.

11. The computer program product of claim 9, wherein registering further comprises:
receiving one or more of the name, the email address and the additional identifying details for the referrer through a third party login to provide the information.

12. The computer program product of claim 11, wherein the third party login includes a login to one or more of a social networking website, a micro-blogging website, and an online profile.

13. The computer program product of claim 9 wherein the referrer is identified by first name and last name.

14. The computer program product of claim 9, wherein the additional information includes one or more of: an image of the referrer, an email for the referrer, a telephone number for the referrer, a complete address for the referrer, a partial address for the referrer, a username for the referrer, a customer identification number for the referrer, and a code for the referrer.

15. The computer program product of claim 9, wherein the method performed by the processor further comprises:
granting a reward to the referred party after a specified act has been completed by the referred party.

16. The computer program product of claim 9, wherein the reward includes one or more of:
a coupon code, cash, rebate, third party vouchers, a free product, free services, upgrades, virtual goods, charity donations, points.

17. A referral program system, comprising:
a database;
a processor; and
a memory storing instructions that when executed by the processor causes the processor to:
register in the database one or more of: a name and additional identifying details for a referrer;
receive, from a referred party, a referrer's name;
verify whether the referrer's name provided by the referred party matches a registered referrer's name in the database, wherein additional identity information is used to verify a referrer's identity where two registered referrers have identical names; and
grant a reward to the referrer after a specified act has been completed by the referred party.
